(19) United States
(12) Patent Application Publication
(10) Pub. No.: US 2006/0230849 A1
(43) Pub. Date: Oct. 19, 2006

(54) Ball screw device

(75) Inventor: Takayuki Yabe, Maebashi-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK ltd., Tokyo (JP)

(21) Appl. No.: 10/567,375

(22) PCT Filed: Jan. 7, 2005
(86) PCT No.: PCT/JP05/00149

§ 371 Date: Feb. 7, 2006

(30) Foreign Application Priority Data
Jan. 9, 2004 (JP) 2004-004830

(51) Int. Cl. F16H 27/02

(52) U.S. Cl. 74/89.23

(57) ABSTRACT

A ball screw device 1 has a screw shaft assembly 15, a nut 7 having an inner diameter smaller than the outer diameter of the screw shaft assembly 15 and formed in a tubular shape, and balls 9 rolling on helical raceway grooves 3, 8 formed in the outer peripheral surface of the screw shaft assembly 15 and the inner peripheral surface of the nut 7. The screw shaft assembly 15 has a first screw shaft 16, a second screw shaft 17 having a shaft raceway groove 3 with the lead same as the lead of a shaft raceway groove 3 formed in the first screw shaft 16, and a screw-in spacer 11 having the inner peripheral surface fitted on shaft sections 18, 19 each formed on one end of each of the first and the second screw shafts 16, 17.

### TECHNICAL FIELD

The present invention concerns a ball screw device used, for example, as a feeding mechanism for a moving body of a machinery apparatus such as a tool machine, precision machine, or transporting apparatus.

### BACKGROUND ART

Generally, in a case of changing the stroke of a ball screw device, it is coped with by manufacturing a single ball screw shaft in accordance with the stroke.

In this case, when a plurality of screw shafts are connected into one ball screw shaft, the length of the ball screw shaft can be easily changed to cope with versatile demands for the change of the stroke in the ball screw device but no prior arts of connecting a plurality of screw shafts into one ball screw shaft are present.

As the prior art of connecting a plurality of shafts, an axial stepped concave portion having a fitting hole and a screw hole is formed to the end of one of the shaft to be connected, and a stepped concave portion having a fitting portion and a screw portion is formed to the end of the other of the shafts, and the screw portion is screwed into to the screw hole and the fitting portion is press-fitted into the fitting hole, thereby preventing radial positional displacement between the connected two shafts (refer to, for example, JP5-279928A).

However, in the shaft-connection technique described above, while the radial displacement between the two shafts can be prevented, since the circumferential position thereof is determined by the phase at the beginning of the meshing of the screw portion to the screw holes and the screwed length upon abutment of the abutting faces of both of the shafts, it involves a problem that alignment of ball rolling groove formed on the outer circumferential surface of the screw shaft is difficult which is inherent to the ball screw shaft of the ball screw device.

The present invention has been achieved for solving the foregoing problem and it is an object thereof to provide means forming a screw shaft by joining that can be used for a ball screw device.

For solving the foregoing subject, the present invention is characterized by providing a ball screw device comprising a plurality of screw shafts each having an outer circumferential surface and a spiral shaft raceway groove formed on the outer circumferential surface, a joining member for joining the screw shafts, a nut having an inner circumferential surface with a nut raceway groove opposed to the shaft raceway groove, and a plurality of balls loaded between the shaft raceway groove and the nut raceway groove, in which a screw shaft assembly is formed by joining the plurality of screw shafts with the joining member while aligning the phase of the shaft raceway grooves thereof, and the shaft raceway groove of the screw shaft assembly and the nut raceway groove are screw coupled by way of the plurality of balls.

In the ball screw device according to the present invention, since a screw shaft assembly is formed by joining a plurality of screw shafts while aligning the phase of the raceway grooves thereof by the joining member, balls loaded in the nut can be passed smoothly over the joining member, and the length of the screw shaft assembly can be changed easily to provide an effect capable of coping with versatile demands for charging the stroke of the ball screw device.

### BRIEF DESCRIPTION OF THE DRAWINGS

FIG. 1 is a cross sectional view of a ball screw device according to a first example of the present invention.

FIG. 2 is a cross sectional view of a screw-in spacer shown in FIG. 1.

FIG. 3 is a view showing a schematic constitution of a ball screw device according to a second example of the present invention.

FIG. 4 is a cross sectional view of the screw-in spacer shown in FIG. 3.

FIG. 5 is a front elevational view showing a screw-in spacer of a ball screw device according to a third example of the present invention.

FIG. 6 is a front elevational view showing a screw-in spacer of a ball screw device according to a fourth example of the present invention.

FIG. 7 is a cross sectional view of a ball screw device according to a fifth example of the present invention.

FIG. 8 is a cross sectional view of a ball screw device according to a sixth example of the present invention.

FIG. 9 is a cross sectional view of the screw-in spacer shown in FIG. 8.

FIG. 10 is a cross sectional view showing a ball screw device according to a seventh example of the present invention.

FIG. 11 is a side elevational view showing a screw shaft assembly of a ball screw device according to an eighth example of the present invention.

FIG. 12 is a side elevational view of a coil body shown in FIG. 11.

FIG. 13 is a side elevational view showing a screw shaft assembly of a ball screw device according to a ninth example of the present invention.

### BEST MODE FOR PRACTICING THE INVENTION

Examples of a ball screw device according to the present invention are to be described with reference to the drawings.

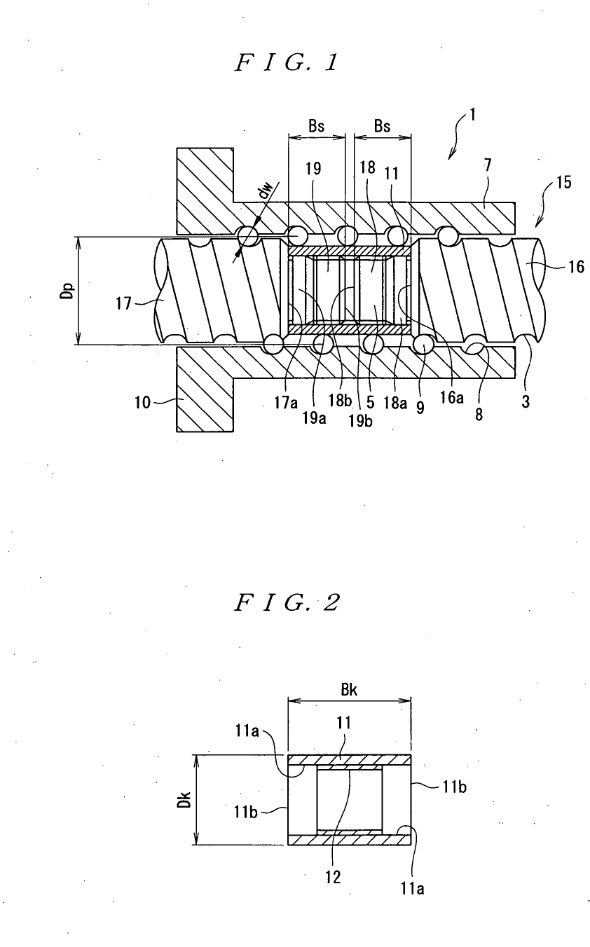

FIG. 1 is a cross sectional view of a ball screw device according to a first example of the present invention, and FIG. 2 is a cross sectional view of a screw-in spacer shown in FIG. 1. In FIG. 1, a ball screw device 1 according to the first example comprises a screw shaft assembly (ball screw shaft) 15, a nut 7 and a plurality of balls 9.

The nut 7 is formed of a steel material such as an alloy steel or carbon steel. Further, the nut 7 is formed into a tubular shape with an inner diameter larger than the outer diameter of the screw shaft assembly 15, and has a spiral nut raceway groove 8 and a flange portion 10 for fixing the nut 7 to a moving body, etc. of a machine apparatus by a plurality of not illustrated bolts. The flange portion 10 is formed at one end of the nut 7, and has a plurality of bolt holes for inserting the not illustrated bolt therethrough.

The nut raceway groove 8 is formed into a substantially semi-arc shape in the cross section. Further, the nut raceway groove 8 is formed at a constant lead on an inner circumferential surface of the nut 7, and opposed to a shaft raceway groove 3 of the screw shaft assembly 15 to be described later.

The ball 9 is made, for example, of a steel material such as alloy steel or a ceramic material, and rolls on the raceway groove 3, 8 for the screw shaft assembly 15 and the nut 7 when the screw shaft assembly 15 rotates. Then, the ball 9 after rolling along the nut raceway groove 8 enters a ball return tube (not illustrated) assembled to the nut 7, and is returned to the initial position passing through a ball return channel formed in the ball return tube.

The screw shaft assembly 15 is constituted including a first screw shaft (shaft body) 16, a second screw shaft (shaft body) 17 and a screw-in spacer (sleeve) 11 as a joining member. The first and the second screw shafts 16, 17 are formed each into a circular cross sectional shape with a diameter smaller than the inner diameter of the nut 7, and have shaft raceway grooves 3 respectively. The shaft raceway grooves 3 are formed on outer circumferential surfaces of the screw shafts 16, 17 at the same lead as that of the nut raceway groove 8 of the nut 7.

Further, the first and the second screw shafts 16, 17 have at one ends thereof shaft portions 18, 19 that fit the sleeve 11. The shaft portions 18, 19 are formed each with an outer diameter smaller than the outer diameter of the screw shafts 16, 17 coaxially with the screw shafts 16, 17, and have male screw portions 5 at the top ends thereof, respectively.

The screw-in spacer 11 is formed into a tubular shape under the condition satisfying the following relations (1) and (2) assuming the outer diameter thereof as Dk (refer to FIG. 2) and has an inner circumferential surface 11a that fits, for example, by movable fit with an outer circumferential surface 18a of the shaft portion 18 and an outer circumferential surfaces 19a of the shaft portion 19:
Dk≦Dp−dw (1)
Dk≧Dp−dw−0.1dw (2)
in which

Dp: Diameter for ball pitch circle (refer to FIG. 1),

dw: Ball diameter.

Further, the screw-in spacer 11 is formed into a tubular shape under the condition satisfying the following relations (3) and (4) assuming the axial length being as Bk, and has a female portion 12 screw coupling with the male screw portions 5 of the shaft portions 18, 19:
Bk≦Bn (3)
Bk>Bs (4),
in which

Bn: axial length corresponding to the effective number of turn of the nut raceway groove 8,

Bs: axial length of the shaft portions 18, 19.

The female portion 12 of the screw-in spacer 11 is formed at a central portion on the inner circumferential surface of the screw-in spacer 11 at a lead smaller than the lead for the shaft raceway groove 3 and at a length exceeding twice the axial length of the male screw portion 5. Further, the female screw portion 12 is formed at the central portion on the inner circumferential surface of the screw-in spacer 11 at a length shorter than the axial length Bk of the screw-in spacer 11.

A circulation channel is formed with the shaft raceway groove 3 of the screw shaft assembly 15, the nut raceway groove 8 of the nut corresponding thereto and a not illustrated return tube connecting them, and the balls 9 and a predetermined amount of a lubricant, for example, grease are sealed in the circulation channel.

Thus, the shaft raceway groove 3 and the nut raceway groove 8 are screw coupled by way of the balls 9, and the nut 7 is moved in the axial direction by rotating the screw shaft assembly 15 or the nut 7 while circulating the balls 9 through the circulation channel.

Further, formation of the shaft portions 18, 19 at the ends of the screw shafts may be saved.

In the constitution described above, when the male screw portions 5 of the shaft portions 18, 19 are screwed into the female portion 12 of the screw-in spacer 11, as shown in FIG. 1, the first screw shaft 16 and the second screw shaft 17 are connected in a state with a clearance being formed between the top end face 18b of the shaft portion 18 and the top end face 19b of the shaft portion 19. Accordingly, by setting the axial length Bs for each of the shaft portions 18, 19 such that the axial length Bk of the screw-in spacer 11 is equal with the length of the lead of the shaft raceway groove 3 between the end face 16a of the shaft 16 and the end face 17 of the screw shaft 17, the screw shaft 16 and the screw shaft 17 can be connected in a state where the phase of the shaft raceway groove 3 formed to the outer circumferential surface of the screw shaft 16 and the phase of the shaft raceway groove 3 formed to the outer circumferential surface of the screw shaft 17 are aligned, by screwing the male screw portions 5 of the shaft portions 18, 19 into the female screw portion 12 of the screw-in spacer 11 till the end faces 16a, 17a of the screw shafts 16, 17 abut against the end faces 11b of the screw-in spacer 11.

In this example, the axial length Bk of the screw-in spacer 11 is set to the length of the lead of the shaft raceway groove 3 cut between the screw shafts 16 and 17, and the angle for the fraction is equally divided, to determine the phase difference between the beginning of meshing where the male screw portion 5 of each shaft portion 18, 19 starts meshing with the female screw portion 12 of the screw-in spacer 11 and the shaft raceway groove 3 at each of stepped end faces 16a, 17a of the screw shafts 16, 17 and the number of screw rotation (means the number of rotation from the beginning of the meshing between the male screw portion 5 and the female screw portion 12 till the abutment of the end face 11b of the screw-in spacer 11 and the stepped end faces 16a, 17a of the screw shaft 16).

For example, in a case where the length of the cut lead of the shaft raceway groove 3 corresponds to 1.5 lead, the angle for the fraction is 180° (360×0.5) and, in a case where the screw-rotational number is set to an integer, the phase difference between the beginning for the meshing where the male portions 5 of the shaft portions 18, 19 start meshing with a female screw portion 12 of the screw-in spacer 11 and the raceway groove 3 at each of end faces 16a, 17a of the screw shafts 16, 17 is determined as 90° (180°/2).

In a case where the number screw rotation having a fraction is set, the phase difference may be decided by adding the angle for the fraction to the angle determined from the fraction of the lead.

Further, the phase difference between the beginning of meshing for the male screw portion 5 of the screw shafts 16, 17 with the female shaft portion 12 of the screw-in spacer 11, and the shaft raceway groove 3 at the end faces 16a, 17a of the screw shafts 16, 17 may be set such that the sum is equal with the angle determined from the fraction of the lead, and the respective number of screw rotation corresponding thereto may be determined.

While this example shows a case in which the end face 11b of the screw-in spacer 11 and the end faces 16a, 17a of the screw shafts 16, 17 abut against each other, the phase for the shaft raceway groove 3 of the screw shafts 16, 17 may not sometimes be aligned even when the end faces abut against each other depending on the fabrication error for each of parts. In such a case, the screwing amount of the screw shafts 16, 17 to the screw-in spacer 11 may be adjusted by additionally fabricating the screw-in spacer 11 to shorten the length of the screw-in spacer 11 or inserting a thin plate such as a thin between the end faces 1b of the screw-in spacer 11 and the end faces 16a, 17a of the screw shafts 16, 17.

Further, it is not always necessary to abut the end face 11b of the screw-in spacer 11 and the end faces 16a, 17a of the screw shafts 16, 17 but a gap may be provided between the end face 11b of the screw-in spacer 11 and the end faces 16a, 17a of the screw shafts 16, 17, so that the face of the shaft raceway grooves 3 formed to the outer circumferential surfaces of the screw shafts 16, 17 is aligned by moving the nut assembled with the balls from one screw shaft to the other screw shaft.

The operation of the constitution described above is to be explained. In a case of joining the screw shafts 16, 17 having the size for each of the portions as described above by using the screw-in spacer 11 as a joining member, the male screw portion 5 of the shaft portion 18 formed at one end of the screw shaft 16 is screwed into the female screw portion 12 of the screw-in spacer 11 and it is further screwed while fitting the outer circumferential surface 18a of the shaft portion 18 and the inner circumferential surface 11a of the screw-in spacer 11 to abut one of the end faces 11b of the screw-in spacer 11 and the end face 16a of the screw shaft 16 to clamp them.

Then, the screw shaft 17 is screwed in the same manner as described above from the opposite side of the screw-in spacer 11 and the other end face 11b of the screw-in spacer 11 and the end phase 17a of the screw shaft 17 are abutted and clamped them.

Thus, two screw shafts 16, 17 can be assembled into a single screw shaft assembly 15 in a state of aligning the phase of the shaft raceway groove 3.

When a ball screw device 1 is assembled by screwing the nut 7 by way of a plurality of balls 9 to the screw shaft assembly 15 and the screw shaft assembly 15 is rotated, for example, the nut 7 moves in the axial direction of the screw shaft assembly 15.

When the nut 7 reaches the joined portion between the screw shaft 16 and the screw shaft 17, the ball 9 is detached from the shaft raceway groove 3 of the screw shaft 16, guided along the nut raceway groove 8 while being supported on the outer circumferential surface of the screw-in spacer 11, rolls on the outer circumferential surface of the screw-in spacer 11, and reaches the end phase 17a of the screw shaft 17. Then, when the ball 9 reaches the end face 17 of the screw shaft 17, the ball 9 transfers to the shaft raceway groove 3 of the screw shaft 17 and rolls on the shaft raceway groove 3 of the screw shaft 17.

In this case, since the axial length Bk of the screw-in spacer 11 is the length for the lead of the shaft raceway groove 3 cut out between the screw shafts 16, 17, and the phase of the shaft raceway grooves 3 of the screw shafts 16, 17 are aligned by the number of screw rotation and the phase difference between the beginning for the meshing of the female screw portion 12 with the male screw portion 5 and the opening end of the shaft raceway groove 3, the ball 9 can move smoothly from the screw shaft 16 to the screw shaft 17 passing over the screw-in spacer 11.

Further, since the outer diameter Dk of the screw-in spacer 11 is made equal with or less than the diameter obtained by subtracting the diameter Dw of the ball 9 from the ball pitch circle diameter Dp, the ball 9 rolls on the outer circumferential surface of the spacer 11 in a state being put between the nut raceway groove 8 and the outer circumferential surface of the spacer 11, so that this can prevent increase of the moving resistance of the nut 7.

Further, since the shaft portions 18, 19 are formed coaxially with the screw shafts 16, 17, when the screw shafts 16, 17 are connected by the screw-in spacer 11, the coaxial state can be maintained.

Further, since the axial length Bk of the screw-in spacer 11 is made equal with or less than the axial length corresponding to the effective number of turns of the nut raceway groove 8, when the nut 7 passes over the outer circumference of the screw-in spacer 11, at least one of the plurality of loaded balls 9 can always roll between the shaft raceway groove 3 and the nut raceway groove 8, and the nut 7 can be transferred smoothly from the screw shaft 16 to the screw shaft 17.

Further, since the axial length Bk of the screw-in spacer 11 is made longer than the sum of the axial length of the shaft portions 18 and 19, the end face 11b of the screw-in spacer 11 can be always abutted against the end faces 16a, 17a of the screw shafts 16 and 17, and the axial length of the shaft assembly 15 or the distance between the screw shafts 16, 17 can be controlled easily by controlling the axial length Bk of the screw-in spacer 11.

As has been described above, in the first example, since the screw shaft assembly 15 is formed by connecting the screw shaft 16 and the screw shaft 17 by the screw-in spacer 11 as the joining member while aligning the phase of the shaft raceway groove 3 of the screw shaft 16 and the shaft raceway groove 3 of the screw shaft 17, the balls 9 can be rolled smoothly and the length of the screw shaft assembly (ball screw shaft) 15 can be changed easily thereby capable of coping with various demands for the stroke change of the ball screw device.

Further, since the outer diameter Dk of the spacer 11 is made equal with or less than the diameter formed by subtracting the ball diameter dw from the ball pitch circle diameter Dp, and the ball 9 rolls on the outer circumferential surface of the spacer 11 in a state been put between the nut raceway groove 8 and the outer circumferential surface of the spacer 11, increase of the moving resistance of the nut 7 can be prevented.

Further, since the axial length Bk of the spacer 11 is made equal with or less than the axial length corresponding to the effective number of turns of the nut raceway groove 8, at least one of the plurality of balls loaded can always roll between the shaft raceway groove 3 and the nut raceway groove 8 when the nut 7 passes over the connection portion between the screw shaft 16 and the screw shaft 17, and the nut can be transferred smoothly between a plurality of screw shafts.

In the first example, while descriptions have been made to a case where the number of a plurality of screw shafts constituting the screw shaft assembly is two, the screw shafts can be joined by any number when the screw shafts are joined in the same manner as described above to provide the same effect as described above.

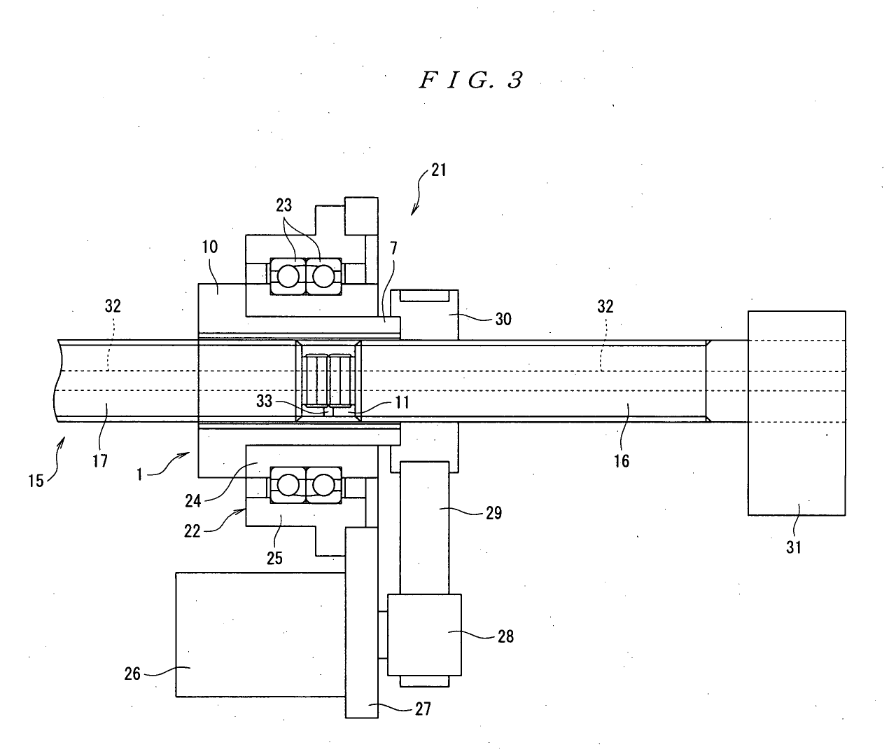

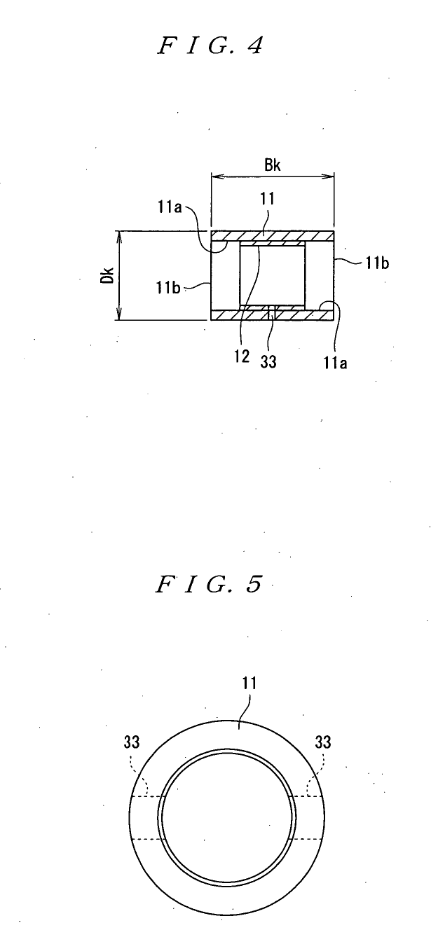

Then, a second example of the invention is to be described with reference to FIG. 3 and FIG. 4, in which portions identical with those shown in FIG. 1 and FIG. 2 carry same reference numerals and detailed explanation for the portions is to be omitted.

In FIG. 3, a ball screw device 1 according to the second example comprises a screw shaft assembly (ball screw shaft) 15, a nut 7 and a plurality of balls 9. The nut 7 is formed into a tubular shape with an inner diameter larger than the outer diameter of the screw shaft assembly 15 and has a spiral nut raceway groove 8. The nut raceway groove 8 is formed at a constant lead to an inner circumferential surface of the nut 7 and opposed to a shaft raceway groove 3 of the screw shaft assembly 15.

The nut 7 is rotationally supported by two angular ball bearings 23 contained in a journal box 22 comprising an inner case 24 fixed to the outer circumferential surface of the nut 7 and an outer case 25 fixed to a moving table (not illustrated) such as a machine apparatus, and driven rotationally by a driving motor 26 by way of an endless belt 29 such as a timing belt. The driving motor 26 is attached to a motor bracket 27 fixed to the outer case 25 of the journal box 22. The endless belt 29 is laid between a driving pulley 28 attached to the rotational shaft of the driving motor 26 and a driven pulley 30 attached to the nut 7.

When the screw shaft assembly 15 rotates, the ball 9 rolls correspondingly along the raceway grooves 3, 8 of the screw shaft assembly 15 and the nut 7. Then, the ball 9 after rolling along the nut raceway groove 8 enters a ball return tube (not illustrated) assembled to the nut 7 and then returns through a ball return channel formed in the ball return tube to the initial position.

The screw shaft assembly (ball screw shaft) 15 is constituted including a first screw shaft 16, a second screw shaft 17 and a screw-in spacer (sleeve) 41 as a joining member. The screw shaft assembly 15 is supported not rotatably by a shaft relating bed 31 situated on both ends thereof.

The screw-in spacer 11 has, in the shaft core portion thereof, a lubricant channel 32 for guiding a liquid lubricant such as a lubricating oil supplied from the screw shaft retaining beds 31 to the top ends of the shaft portions 18, 19. The lubricant channels 32 have openings at the top end faces 18b, 19b of the shaft portions 18, 19 respectively. The lubricant flowing out of the opening portions of the lubricant channels 32 are supplied flowing through a lubricant supply hole 33 (refer to FIG. 4) provided to the screw-in spacer 11 to the shaft raceway groove 3 of the screw shaft assembly 15, etc. The lubricant supply hole 33 is perforated while avoiding the track of the shaft raceway groove 3 cut between the screw shafts 16, 17 so as not to hinder the movement of the ball 9 passing over the outer circumferential surface of the screw-in spacer 11.

The operation of the constitution is to be described. The ball screw device 1 assembled in the same manner as in the first example described above is assembled as a ball screw device assembly 21 by retaining both ends of the screw shaft assembly 15 to the screw shaft retaining beds 31, fixing the nut 7 to the journal box 22 and laying the endless belt 29 between the driving pulley 28 and the driven pulley 30.

Then, when the motor 26 rotates, the rotational force of the driving pulley 28 is transmitted by way of the endless belt 29 and the driven pulley 28 to the nut 7 and the nut 7 is rotated.

In this case, since the nut 7 is rotatably supported by the angular ball bearing 23, only the nut 7 is rotated and moves in the axial direction on the screw shaft assembly 15 retained at both ends to the screw shaft retaining bed 31, to move the moving bed of the machine apparatus, etc. in the axial direction.

When the nut 7 reaches the joining portion between the screw shaft 16 and the screw shaft 17, the ball 9 rolls on the outer circumferential surface of the screw-in spacer 11 in the same manner as in the first example.

Upon passage of the nut 7 over the joined portion between the screw shaft 16 and the screw shaft 17, a lubricant is fed under pressure from the not illustrated lubricant supplying device, and supplied by way of the screw shaft retaining bed 31 and the lubricant channel 32 from the gap at the end faces of the screw shafts 16, 17 to the inside of the screw-in spacer 11. The lubricant flows through the lubricant supply hole 33 to a portion between the nut 7 and the screw-in spacer 11 to supply the lubricant to the ball passing there. After the passage of the nut 7, supply of the lubricant is terminated.

In this case, since the lubricant supply hole 33 is perforated while avoiding the track of the shaft raceway groove 3 cut between the screw shafts 16 and 17, the ball 9 can be passed smoothly without dropping into the lubricant supply hole 33, as well as a relatively large hole can be perforated to sufficiently supply the lubricant.

Further, provision of the lubricant supply hole 33 is no more necessary by the provision of the lubricant supply hole 33 to the screw-in spacer 11 to facilitate manufacture of the screw shafts 16, 17.

Further, since the screw-in spacer 11 in this example is clamped at the end face 11b thereof being abutted against the stepped end faces 16a, 17a of the screw shafts 16, 17, the lubricant does not leak to the outside.

As has been described above, in the second example, since the lubricant supply hole 33 is provided or formed to the screw-in spacer 11 as the joining member, the lubricant supply hole perforated so far in the shaft raceway groove can be saved to shorten the fabrication time for the screw shaft in addition to the same effect as in the first example.

Further, since the lubricant supply hole 33 is perforated while avoiding the track of the shaft raceway groove 3 cut between the screw shafts 16 and 17, this can prevent the ball 9 from dropping into the lubricant supply hole upon passing over the outer circumferential of the screw-in spacer 11, as well as a relatively large lubricant supply hole can be perforated to sufficiently supply the lubricant.

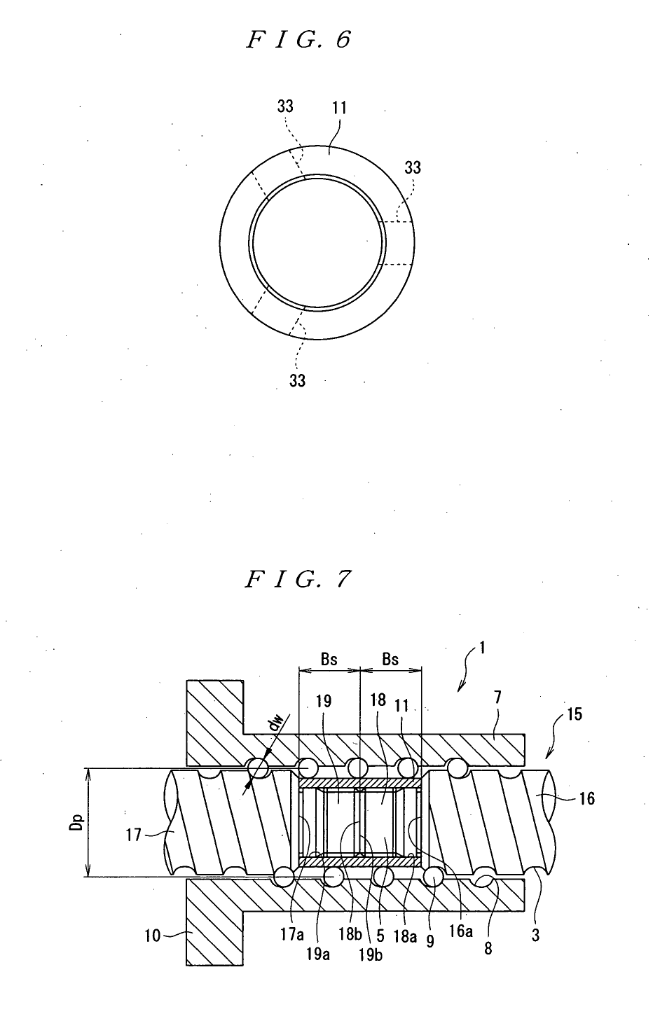

In the second example, while a case of providing one lubricant supply hole 33 to the screw-in spacer 11 is illustrated, two or more lubricant supply holes 33 may be disposed to the screw-in spacer 11 as in the third example shown in FIG. 5 and the fourth example shown in FIG. 6. In summary, the number the lubricant supply holes 33 may be determined in accordance with the amount of the lubricant to be supplied.

Further, in the example shown in FIG. 3 and FIG. 4, it is illustrated such that the track of the shaft raceway groove is downwarded, the circumferential position of the lubricant supply hole is not restricted only to the downward direction but it may be directed laterally or upward. In this case, when the lubricant supply hole is disposed at a position other than the downward direction, particularly, at a laterally directed position or upward position, sagging of the lubricant after passage of the nut can be prevented.

Then, a fifth example of the present invention is to be described with reference to FIG. 7.

In FIG. 7, a ball screw device 1 according to the fifth example comprises a screw shaft assembly (ball screw shaft) 15, a nut 7 and a plurality of balls 9. The nut 7 is formed into a tubular shape with an inner diameter larger than the outer diameter of the screw shaft assembly 15 and has a spiral nut raceway groove 8. The nut raceway groove 8 is formed at a constant lead to an inner circumferential surface of the nut 7 and opposed to a shaft raceway groove 3 of the screw shaft assembly 15 to be described later.

When the screw shaft assembly 15 rotates, the ball 9 rolls correspondingly along the raceway grooves 3, 8 of the screw shaft assembly 15 and the nut 7. Then, the ball 9 after rolling along the nut raceway groove 8 enters a ball return tube (not illustrated) assembled to the nut 7 and then returns through a ball return channel formed in the ball return tube to the initial position.

The screw shaft assembly (ball screw shaft) 15 is constituted including a fist screw shaft 16, a second screw shaft 17, and a screw-in spacer (sleeve) 11 as a joining member. The first and the second screw shafts 16, 17 are formed each into a circular cross sectional shape with a diameter smaller than the inner diameter of the nut 7 and have spiral shaft raceway grooves 3 respectively. The shaft raceway groove 3 is formed on an outer circumferential surface of the screw shafts 16, 17 at the same lead as that of the nut raceway groove 8 of the nut 7.

Further, the screw shafts 16, 17 have at one ends thereof shaft portions 18, 19 that fit the sleeve 11. The shaft portions 18, 19 are formed each with an outer diameter smaller than the outer diameter of the screw shafts 16, 17 coaxially with the screw shafts 16 and 17, and have male screw portions 5 at the top ends thereof.

The screw-in spacer 11 is formed into a tubular shape under the condition satisfying the following relations (1) and (2) assuming the outer diameter being as Dk, and has an inner circumferential surface 11a that fits, for example, by movable fit with the outer circumferential surfaces 18a, 19a of the shaft portions 18, 19:
Dk≦Dp−dw (1)
Dk≧Dp−dw−0.1dw (2)
in which Dp: diameter for ball pitch circle

Dw: ball diameter

Further, the screw-in spacer 11 is formed into a tubular shape under the condition satisfying the following relations (3) and (5) assuming the axial length being as Bk:
Bk≦Bn (3)
Bk>Bs (5)
in which

Bn: axial length corresponding to the effective number of turns of the nut raceway groove 8,

Bs: axial length of shaft portion 18, 19

A female screw portion 12 is formed at a central portion on an inner circumferential surface of the screw-in spacer 11 with a lead smaller than the lead of the shaft raceway groove 3 and at a length exceeding twice the axial length of the female screw portion 5. Further, the female screw portion 12 is formed at a central portion on the inner circumferential surface of the screw-in spacer 11 at a length shorter than the axial length Bk of the screw-in spacer 11.

With the constitution as described above, when the male screw portions 5 of the shaft portions 18, 19 are press-in fitted into the female screw portion 12 of the spacer 11, as shown in FIG. 7, the first screw shaft 16 and the second screw shaft 17 are connected in a state where the top end face 18a of the shaft potion 18 and the top end face 19a of the shaft portion 19 are abutted. Accordingly, when the axial length Bs of the shaft portions 18, 19 is set such that the axial length Bk of the shaft portions 18, 19 is ½ for the lead length of the shaft raceway groove 3 between the end face 16a of the screw shaft 16 and the end face 17b of the screw shaft 17, the screw shaft 16 and the screw shaft 17 can be connected in a state of aligning the phase of the raceway grooves 3 formed on the outer circumferential surface of the screw shaft 16 and the phase of the shaft raceway groove 3 formed on the outer circumferential surface of the screw shaft 17 by screwing the male screw portion 5 of the shaft portions 18, 19 into the female portion 12 of the spacer 11 till the end face 18b of the shaft portion 18 and the top end face 19b of the shaft portion 19b of the shaft portion 19 abut against each other.

Further, the phase difference between the beginning of meshing of the male screw portion 5 with the female screw portion 12 and the opening end of the shaft raceway groove 3 may be set such that the sum is equal with the angle determined from the fraction of the lead and the number of screw rotation and the axial length Bs of the shaft portions 18, 19 may be determined correspondingly.

The operation of the constitution described above is to be explained.

In a case of joining the screw shafts 16, 17 having the size for each of the portions described above using the screw-in spacer 11 as the joining member, the male screw portion 5 of the shaft portion 18 formed at one end of the screw shaft 16 is screwed into the female screw portion 12 of the screw-in spacer 11, and further screwed while fitting the outer circumferential surface 18a of the shaft portion 18 and the inner circumferential surface 11a of the spacer 11 to rotate by the predetermined number of screw rotation.

Then, the screw shaft 17 is screwed by the number of screw rotation in the same manner as described above from the opposite side of the screw-in spacer 11, and the top end faces of the shaft portions 18, 19 are abutted against each other at the inside of the screw-in spacer 11 and clamped.

Thus, two screw shafts 16, 17 can be assembled as a single screw shaft assembly in a state of aligning the phases of the shaft raceway grooves 3.

Since other assembling of the ball screw device 1, operation of the ball 9 passing over the screw-in spacer 11, etc. are identical with those in the first embodiment described above, the description therefor is to be omitted.

As has been described above, in the fifth example, since the axial length Bk of the screw-in spacer 11 is made shorter than the sum for the axial length Bs of the shaft portions 18, 19, the end faces of the screw shafts 16, 17 can be always abutted against each other, and the axial length of the screw shaft assembly 15 and the distance between the screw shaft 16 and 17 can be controlled easily by controlling the axial length Bs of the shaft portions 18, 19, and the productivity of the spacer can be improved by setting the finishing accuracy for the axial length Bk of the screw-in spacer 11 to a moderate level.

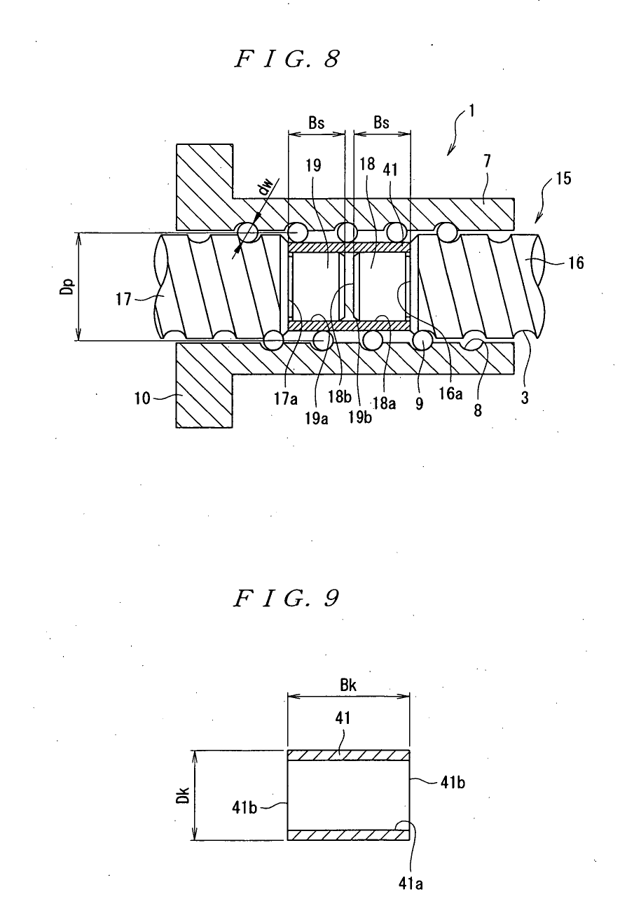

Then, a sixth example of the present invention is to be described with reference to FIG. 8 and FIG. 9.

In FIG. 8, a ball screw device 1 according to the sixth example comprises a screw shaft assembly (ball screw shaft) 15, a nut 7 and a plurality of balls 9. The nut 7 is formed into a tubular shape with an inner diameter larger than the outer diameter of the screw shaft assembly 15, and has a spiral nut raceway groove 8. The nut raceway groove 8 is formed at a constant lead on an inner circumferential surface of the nut 7 and opposed to a raceway groove 3 of the screw shaft assembly 15 to be described later.

When the screw shaft assembly 15 rotates, the ball 9 rolls correspondingly along the raceway grooves 3, 8 of the screw shaft assembly 15 and the nut 7. Then, the ball 9 after rolling along the nut raceway groove 8 enters a ball return tube (not illustrated) assembled to the nut 7 and then returns through a ball return channel formed in the ball return tube to the initial position.

The screw shaft assembly (ball screw shaft) 15 is constituted including a fist screw shaft 16, a second screw shaft 17, and a screw-in spacer (sleeve) 41 as a joining member.

The first and the second screw shafts 16, 17 are formed each into a circular cross sectional shape with a diameter smaller than the inner diameter of the nut 7, and have spiral shaft raceway grooves 3 respectively. The shaft raceway groove 3 is formed to the outer circumferential surface of the screw shafts 16, 17 at the same lead as that of the nut raceway groove 8 of the nut 7.

Further, the screw shafts 16, 17 have at one ends thereof shaft portions 18, 19 that fit the sleeve 41. The shaft portions 18, 19 are formed each with an outer diameter smaller than the outer diameter of the screw shafts 16, 17 coaxially with the screw shafts 16, 17 and have male screw portions 5 at the top ends thereof.

The fitting screw-in spacer 41 has an inner circumferential surface 41a that fits, for example, by press-in fitting with the outer circumferential surfaces 18a, 19a of the shaft portions 18, 19. The fitting screw-in spacer 41 is formed into a tubular shape under the condition satisfying the following relations (1) and (2) assuming the outer diameter being as Dk:
Dk≦Dp−dw (1)
Dk≧Dp−dw−0.1dw (2)
in which

Dp: diameter for ball pitch circle,

Dw: ball diameter.

Further, the screw-in spacer 41 is formed into a tubular shape under the condition satisfying the following relations (3) and (4) assuming the axial length being as Bk:
Bk≦Bn (3)
Bk>Bs (4)
in which

Bn: axial length corresponding to the effective number of turns of the nut raceway groove 8,

Bs: axial length of shaft portion 18, 19.

With the constitution as described above, when the shaft portions 18, 19 of the screw shafts 16, 17 are press-in fitted into the screw-in spacer 41, as shown in FIG. 8, the screw shaft 16 and the screw shaft 17 are connected in a state where a gap is formed between the top end face 18a of the shaft potion 18 and the top end face 19a of the shaft portion 19. Accordingly, when the axial length Bs of the shaft portions 18, 19 is set such that the axial length Bk of the screw-in spacer 41 is equal with the lead length of the shaft raceway groove 3 between the end face 16b of the screw shaft 16 and the end face 17b of the screw shaft 17, the screw shaft 16 and the screw shaft 17 can be connected in a state of aligning the phase of the raceway groove 3 formed on the outer circumferential surface of the screw shaft 16 and the phase of the shaft raceway groove 3 formed on the outer circumferential surface of the screw shaft 17 by inserting the shaft portions 18, 19 of the screw shafts 16, 17 into the screw-in spacer 41 till the end faces 16a, 17a of the screw shafts 16, 17 about against the end faces 41b of the screw-in spacer 41.

The operation of the constitution described above is to be explained.

In a case of joining the screw shafts 16, 17 having the size for each of the portions described above using the screw-in spacer 41 as the joining member, the shaft portion 18 of the screw shaft 16 is press-in fitted into the screw-in spacer 41 to abut the end face 41b of the screw-in spacer 41 against the end face 16a of the screw shaft 16.

Then, a jig identical with the nut 7 loaded with a plurality of balls 9 is screw coupled to the screw shaft 16 and fixed to the joining portion, and the shaft portion 19 of the screw shaft 17 is press-in fitted into the screw-in spacer 41 from the side opposite to the screw shaft 16 while screw coupling the shaft raceway groove 3 of the screw shaft 17 with the ball 9 in the same manner as described above.

In this case, since the jig is fixed, the screw shaft 17 is enforced under rotation while being guided by the ball 9 of the jig along with the axial movement of the screw shaft 17 by press-in fitting, and the end face 41b of the screw-in spacer 41 and the end faces 16a, 17a of the shaft screws 16, 17 are abutted.

Thus, the two screw shafts 16, 17 can be assembled as a single screw shaft assembly 15 in a state with the phase of the shaft raceway grooves 3 being aligned.

Since other assembling of the ball screw device 1, operation of the ball passing through the screw-in spacer 11, etc. are identical with those in the first example described above, description thereof is to be omitted.

As has been described above, in the sixth example, in addition to the same effect as in the first example, since the screw shaft assembly is formed by press-in fitting by forming the axial length Bk of the screw-in spacer 41 longer than the sum of the axial length Bs for the shaft portions 18, 19, the end faces 41b of the screw-in spacer 41 can always be abutted against the end faces 16a, 17a of the screw shafts 16, 17, the axial length of the screw shaft assembly and the distance between the screw shafts 16, 17 can be controlled easily by controlling the axial length Bk of the screw-in spacer 41, as well as the phases of the raceway grooves of the screw shafts can be aligned easily to improve the productivity of the screw-in spacer as the joining member.

In the case of joining the screw shafts by press-in fitting using the screw-in spacer in this example, the same effect as in the second example can be obtained by forming the same lubricant supply hole 33 to the screw-in spacer 41 and disposing a lubricant channel 32 to the screw shafts 16, 17 as in the second example.

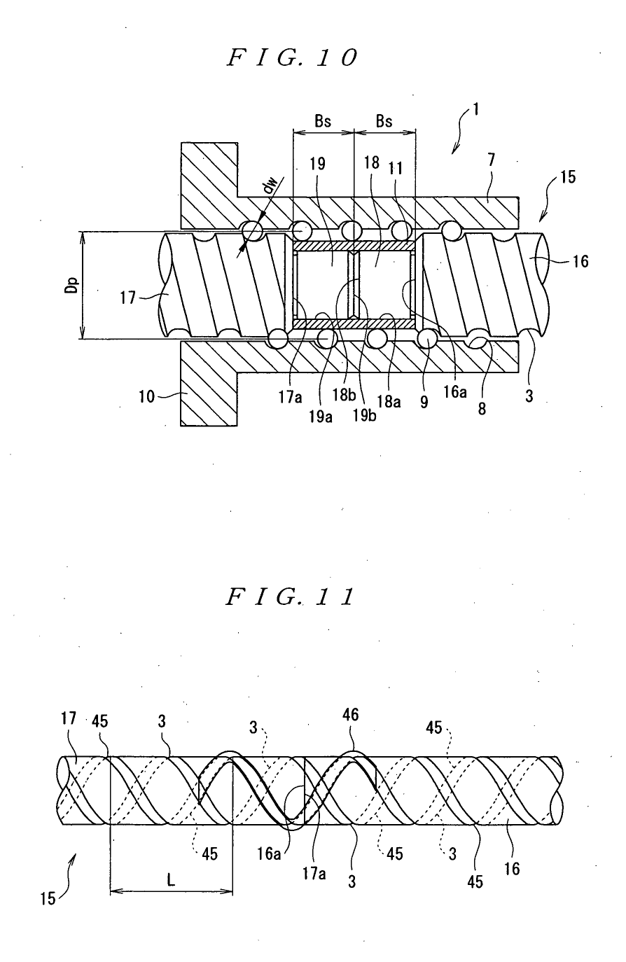

Then, a seventh example of the invention is to be described with reference to FIG. 10.

In FIG. 10, a ball screw device 1 according to the seventh example comprises a screw shaft assembly (ball screw shaft) 15, a nut 7 and a plurality of balls 9. The nut 7 is formed into a tubular shape with an inner diameter larger than the outer diameter of the screw shaft assembly 15 and has a spiral nut raceway groove 8. The nut raceway groove 8 is formed at a constant lead on an inner circumferential surface of the nut 7 and opposed to a raceway groove 3 of the screw shaft assembly 15 to be described later.

When the screw shaft assembly 15 rotates, the ball 9 rolls correspondingly along the raceway grooves 3, 8 of the screw shaft assembly 15 and the nut 7. Then, the ball 9 after rolling along the nut raceway groove 8 enters a ball return tube (not illustrated) assembled to the nut 7 and then returns through a ball return channel formed in the ball return tube to the initial position.

The screw shaft assembly (ball screw shaft) 15 is constituted including a fist screw shaft 16, a second screw shaft 17, and a screw-in spacer (sleeve) 41 as a joining member.

The first and the second screw shafts 16, 17 are formed each into a circular cross sectional shape with a diameter smaller than the inner diameter of the nut 7 and have spiral shaft raceway grooves 3 respectively. The shaft raceway groove 3 is formed on an outer circumferential surface of the screw shafts 16, 17 at the same lead as that of the nut raceway groove 8 of the nut 7.

Further, the screw shafts 16, 17 have at one ends thereof shaft portions 18, 19 that fit the sleeve 41. The shaft portions 18, 19 are formed each with an outer diameter smaller than the outer diameter of the screw shafts 16, 17 coaxially with the screw shafts 16, 17 and have male screw portions 5 at the top ends thereof.

The screw-in spacer 41 has an inner circumferential surface 41a that fits, for example, by press-in fitting with outer circumferential surfaces 18a, 19a of the shaft portions 18, 19 and is formed into a tubular shape under the condition satisfying the following relations (1) and (2) assuming the outer diameter being as Dk:
Dk≦Dp−dw (1)
Dk≧Dp−dw−0.1dw (2),
in which

Dp: diameter for ball pitch serve,

Dw: ball diameter.

Further, the screw-in spacer 41 is formed into a tubular shape under the condition satisfying the following relations (3) and (4) assuming the axial length being as Bk:
Bk≦Bn (3)
Bk<Bs (5)
in which

Bn: axial length corresponding to the effective number of turns of the nut raceway groove 8,

Bs: axial length of shaft portion 18, 19.

With the constitution as described above, when the shaft portions 18, 19 of the screw shafts 16, 17 are press-fitted into the screw-in spacer 41, as shown in FIG. 10, the screw shaft 16 and the screw shaft 17 are connected in a state where the top end face 18b of the shaft potion 18 and the top end face 19b of the shaft portion 19 are abutted. Accordingly, when the axial length Bk of the shaft portions 18, 19 is set such that the axial length Bk of each of the shaft portions 18, 19 is ½ of the lead length of the shaft raceway groove 3 between the end face 16a of the screw shaft 16 and the end shaft 17a of the screw shaft 17, the screw shaft 16 and the screw shaft 17 can be connected in a state where the phase of the shaft raceway groove 3 formed on the outer circumferential surface of the screw shaft 16 and the phase of the shaft raceway groove 3 formed on the outer circumferential surface of the screw shaft 17 are aligned by press-in fitting the shaft portions 18, 19 of the screw shafts 16, 17 into the screw-in spacer 41 till the top end face 18b of the screw shaft 18 and the top end face 19b of the shaft portion 19 are abutted.

The operation of the constitution described above is to be described.

In a case of joining the screw shafts 16, 17 having the size for each of the portions described above by using the screw-in spacer 41 as a joining member, the screw shafts 16, 17 set to a jig are press-in fitted on both sides of the screw-in spacer 41 and the top end faces of the shaft portions 18, 19 are abutted against each other in the inside of the screw-in spacer 41 in the same manner as in Example 4.

Thus, two screw shafts 16, 17 can be assembled as a single screw shaft assembly 15 in a state of aligning the phases of the shaft raceway grooves 3.

Since other assembling of the ball screw device 1, operation of the ball 9 passing the screw-in spacer 41, etc. are identical with the sixth embodiment, description therefor is to be omitted.

As has been described above, the seventh example can provide the same effect as in the fifth and the sixth examples.

In a case of applying the joining of the screw shafts 16, 17 using the screw-in spacer 41 of the sixth and the seventh examples to the ball screw device 1 which is used while retaining the rotation and axial movement of the same screw shaft assembly 15 as in the ball screw device assembly 21 of the second example, movable fit may be adopted for fitting between the inner circumferential surface 41a of the screw-in spacer 41 and the outer circumferential surfaces 18a, 19a of the shaft portions 18, 19.

In this case, since both ends of the screw shaft assembly 15 are retained, joining at the joined portion is not detached. Further, for the phase alignment of the shaft raceway grooves 3 of the screw shafts 16, 17, since fitting between the screw-in spacer 41 and the shaft portions 18, 19 is movable fit and rotation is easy, phase of the shaft raceway grooves 3 can be aligned more easily by using the nut as it is without using any special jig and retaining the screw shaft assembly 15 after aligning the phase for the shaft raceway groove 3 in the same manner as described above.

Further, a lubricant may be supplied to the ball passing through the screw-in spacer or the like by providing a lubricant supply hole of the second example to the sixth and the seventh examples.

In this case, it is preferred to provide a radial recess to one or both of the end faces of the screw shaft to facilitate the supply of the lubricant and seal the space between the screw shafts on both sides and the screw-in spacer with an O-ring, or the like.

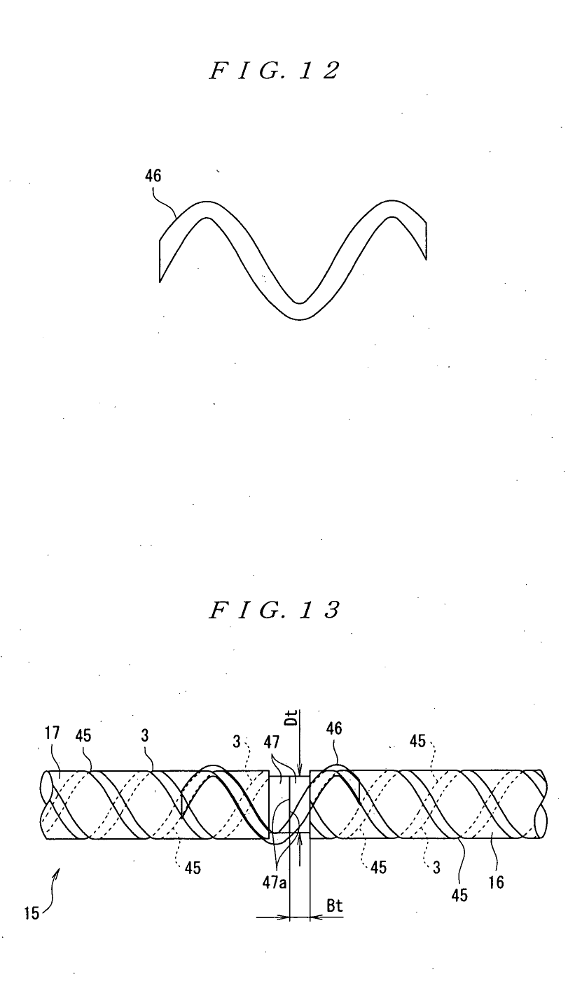

Then, an eighth example of the present invention is to be described with reference to FIG. 11 and FIG. 12.

In FIG. 11 and FIG. 12, screw shafts 16 and 17 of the eighth example have another shaft raceway groove 45 in addition to the shaft raceway groove 3. The shaft raceway groove 45 is formed spirally at a lead identical with that of the shaft raceway groove 3 on the outer circumferential surface of the screw shafts 16, 17.

Accordingly, while the screw shafts 16, 17 of this example have the same constitution as the screw shafts 16, 17 having two shaft raceway grooves 3, 45, balls are not loaded in the shaft raceway groove 45 but it functions as a ball screw device having a screw shaft assembly 15 in which screw shafts 16, 17 having a single strand of the shaft raceway groove 3 are joined.

The screw shaft assembly 15 is constituted including a coil body 46 as a joining member for connecting the screw shaft 16 and the screw shaft 17. The coil body 46 is formed into a circular shape in cross section having a diameter substantially equal with the diameter dw of the ball 9. Further, the coil body 46 is a helical coiled member manufactured by winding a wire material, for example, made of spring steel or alloy steel by one turn or more, which is formed with the winding pitch being equal or less than the lead of the shaft raceway groove 3, 45 (refer to FIG. 11) and with the diameter for the center of the wire material wound in a coil shape (referred to as a coil diameter) being equal with or less than the diameter Dp for ball pitch circle (refer to FIG. 1) and formed so as to conform the shape of another shaft raceway groove 45. The wining number of the coil body 46 in this example is one turn.

The ends of the shaft screws 16, 17 of this example are formed in the same manner as in the case of bisecting a single screw shaft and formed such that the phases for the shaft raceway grooves 3, 45 are aligned when the end faces of the screw shafts 16, 17 are abutted against with each other and rotated.

The operation of the foregoing constitution is to be described.

In a case of joining the screw shafts 16, 17 by using the coil body 46 as the joining member, the end faces of the screw shafts 16, 17 are abutted against each other, and the coil body 46 is mounted by winding it along another shaft raceway groove 45.

In this case, since the coil body 46 has a shape substantially identical with the ball diameter dw, the winding pitch is made equal with or less than the lead of the shaft raceway groove 45, and the coil diameter is made equal with or less than the diameter Dp for the ball pitch circle, it is in close contact with another shaft raceway groove 45 by the resiliency of a spring steel or alloy steel to align the phase of another shaft raceway groove 45 and, at the same time, align the phase of the shaft raceway groove 3. Further, since the number of winding of the coil body 46 is set to one turn or more, a coaxial relation can be kept.

Thus, two screw shafts 16, 17 can be assembled as a single screw shaft assembly 15 in a state of aligning the phases of the shaft raceway grooves 3 of the two screw shafts 16, 17.

The thus assembled screw shaft assembly 15 can function in the same manner as a single shaft screw with no joining.

Accordingly, the operation of the ball 9 passing through the connection portion of the shaft raceway groove 3 or the nut 7 is identical with a usual screw shaft.

As has been described above, in the eighth example, since another shaft raceway groove not loaded with balls is disposed to the screw shaft, and a coil body is wound around another shaft raceway groove as the joining member to join the screw shafts into a screw shaft assembly, the phase of the shaft raceway groove can be aligned easily by merely winding the coil body along the shaft raceway groove of the screw shafts in addition to the same effect as in the first example.

The coil body of this example can also be used as a jig upon assembling the screw shaft assembly of the sixth and the seventh examples.

Then, a ninth example of the present invention is to be described. Portions identical or corresponding to those shown in FIG. 11 and FIG. 12 carry same reference numerals and the description for the portions is to be omitted.

In FIG. 13, screw shafts 16, 17 of the ball screw device according to the ninth example have shaft portions 47 each formed with a diameter smaller than the outer diameter of the screw shafts 16, 17 at one ends thereof. The shaft portion 47 is formed to each end of the screw shafts 16, 17 under the condition satisfying the following relation (6) assuming the diameter thereof being as Dt:
Dt≦Dp−dw (6)
in which

Dp: diameter for ball pitch circle,

dw: diameter for ball.

Further, the shaft portion 47 is formed to each one end of the screw shafts 16, 17 under the condition satisfying the following relation (7) assuming the axial length thereof being as Bt:
Bt≦Bn/2 (7)
in which

Bn: axial length corresponding to the effective number of turns in the nut raceway groove 8.

Further, the shaft portion 47 is formed to each one ends of the screw shafts 16, 17 under the condition satisfying the following equation (8) assuming the lead length of the shaft raceway grooves 3, 45 cut between the screw shafts 16 and 17 being as L:
Bt=L/2 (8)

In this example, the axial length Bt of the shaft portion 47 is formed by equally dividing the predetermined length described above. Thus, it is formed such that the phases of the shaft raceway grooves 3, 45 are aligned when the end faces of the shaft portions 47 are abutted against with each other and rotated.

The operation of the constitution described above is to be described.

In a case of joining the screw shafts 16, 17 by using the coil body 46 as the joining member, the end faces of the screw shafts 16, 17 are abutted against each other, the coil body 46 is wound around and attached to another shaft raceway groove 45, the coil body 46 is in close contact with another shaft raceway groove 45 by the resiliency of the coil body 46 to align the phase of another shaft raceway groove 45 and, at the same time, align the phase of the shaft raceway groove 3 in the same manner as in the eighth example.

In this case, since the outer diameter Dt of the shaft portion 47 is defined as identical with or less than the diameter obtained by subtracting the diameter dw for the ball 9 from the diameter Dp for the ball pitch circle in the same as the outer diameter Dk for the screw-in spacer 11 of the first example, it can function in the same manner to the ball 9 or the nut 7 passing through the outer circumferential surface of the shaft portion 47.

Thus, two screw shafts 16, 17 can be assembled as a single screw shaft assembly 15 in a state of aligning the phase of the shaft raceway groove 3.

The thus assembled screw shaft assembly 15 functions in the same manner as the first example.

As has been described above, the ninth example can provide the same effect as that of the first example and the eighth example.

In the eighth and the ninth examples described above, while description has been made that the shaft raceway groove for loading the balls has a single strand, the shaft raceway groove for loading the balls is not restricted to the single strand but may also strands of any number.

In this case, another shaft raceway groove is formed by adding one strand to the raceway groove for loading the balls.

In each of the examples described above, while description has been made to the example of the ball screw device having the return tube type communication channel, the communication channel is not restricted to that described above but the same effect can be obtained also by applying the present invention to a ball screw device in which the communication channel is constituted as a die type or end cap type.

Further, in each of the examples described above, while descriptions have been made mainly that the nut is moved in the axial direction by rotating the screw shaft of the ball screw device, the same effect can be provided also by applying the invention to a ball screw of a type of rotating the nut while fixing the screw shaft.

1. A ball screw device comprising a plurality of screw shafts each having an outer circumferential surface and a spiral shaft raceway groove formed on the outer circumferential surface, a joining member for joining the screw shafts, a nut having an inner circumferential surface with a nut raceway groove opposed to the shaft raceway groove, and a plurality of balls loaded between the shaft raceway groove and the nut raceway groove, in which
a screw shaft assembly is formed by joining while aligning the phases of the shaft raceway grooves of the plurality of screw shafts by the joining member and screw coupling the shaft raceway groove and the nut raceway groove of the screw shaft assembly by way of the plurality of balls.

2. A ball screw device according to claim 1 wherein
the outer diameter of the joining member is made identical with or less than the diameter obtained by subtracting the diameter of the ball from the diameter of the ball pitch circle for the plurality of loaded balls.

3. A ball screw device according to claim 1, wherein
the axial length of the joining member is made identical with or less than the axial length corresponding to the effective number of turns of the nut.

4. A ball screw device according to claim 1, wherein
the screw shafts are joined by abutting the stepped end faces of the screw shafts and the end faces of the joining member.

5. A ball screw device according to claim 1, wherein
the screw shafts are joined by abutting the end faces of the screw shafts in the inside of the joining member.

6. A ball screw device according to claim 1, wherein
a lubricant channel is provided to a shaft core portion of the screw shaft and a lubricant supply hole is provided to the side wall of the joining member.

7. A ball screw device according to claim 6, wherein
the lubricant is supplied from the lubricant supply hole when the nut passes over the joining member

8. A ball screw device according to claim 1, wherein
another shaft raceway groove not loaded with the balls is disposed to the plurality of screw shafts, the joining member is formed as a spiral coil body along the shaft raceway groove, and the coil body is wound around another shaft raceway groove, thereby joining the screw shafts.

9. A ball screw device according to claim 2, wherein
the axial length of the joining member is made identical with or less than the axial length corresponding to the effective number of turns of the nut.

10. A ball screw device according to claim 2, wherein
the screw shafts are joined by abutting the stepped end faces of the screw shafts and the end faces of the joining member.

11. A ball screw device according to claim 3, wherein
the screw shafts are joined by abutting the stepped end faces of the screw shafts and the end faces of the joining member.

12. A ball screw device according to claim 2, wherein
the screw shafts are joined by abutting the end faces of the screw shafts in the inside of the joining member.

13. A ball screw device according to claim 3, wherein
the screw shafts are joined by abutting the end faces of the screw shafts in the inside of the joining member.

14. A ball screw device according to claim 2, wherein
a lubricant channel is provided to a shaft core portion of the screw shaft and a lubricant supply hole is provided to the side wall of the joining member.

15. A ball screw device according to claim 3, wherein
a lubricant channel is provided to a shaft core portion of the screw shaft and a lubricant supply hole is provided to the side wall of the joining member.

16. A ball screw device according to claim 4, wherein
a lubricant channel is provided to a shaft core portion of the screw shaft and a lubricant supply hole is provided to the side wall of the joining member.

17. A ball screw device according to claim 5, wherein
a lubricant channel is provided to a shaft core portion of the screw shaft and a lubricant supply hole is provided to the side wall of the joining member.
